(19) United States
(12) Patent Application Publication
(10) Pub. No.: US 2018/0322393 A1
(43) Pub. Date: Nov. 8, 2018

(54) NEURAL NETWORK, CORRESPONDING DEVICE, APPARATUS AND METHOD

(71) Applicant: STMICROELECTRONICS S.R.L., Agrate Brianza (IT)

(72) Inventors: Danilo Pietro PAU, Sesto San Giovanni (IT); Marco PIASTRA, Pavia (IT); Luca CARCANO, Pavia (IT)

(21) Appl. No.: 15/965,803

(22) Filed: Apr. 27, 2018

(30) Foreign Application Priority Data
May 2, 2017 (IT) 102017000047044

(51) Int. Cl. G06N 3/08; G06F 3/01

(52) U.S. Cl. CPC G06N 3/088; G06F 3/017; G06F 3/011

(57) ABSTRACT

A neural network includes one layer of neurons including neurons having neuron connections to neurons in the layer and input connections to a network input. The neuron connections and the input connections have respective neuron connection weights and input connection weights. The neurons have neuron responses set by an activation function with activation values and include activation function computing circuits configured for computing current activation values of the activation function as a function of previous activation values of the activation function and current network input values.

### BACKGROUND

### Technical Field

The description relates to neural networks.

One or more embodiments may relate to neural networks for use in activity recognition in wearable devices, for instance.

### Description of the Related Art

Neural networks are good candidates for use in activity detection, for instance in wearable devices. A neural network can be embedded in a wearable, low-power system in order to perform processing tasks such as classification of incoming signals in order to detect an activity performed by the user (for instance: jogging, walking, running, biking, stationary state and so on).

Neural networks have formed the subject matter of extensive research, as witnessed, e.g., by:
H. Jaeger: “The “echo state” approach to analyzing and training a recurrent neural networks”, GMD Report 148, German National Research Center for Information Technology, 2001 (with erratum note published on Jan. 26, 2010);
M. Lukoševičius: “Self-organized reservoirs and their hierarchies”, Jacobs University Bremen, Campus Ring 1, Bremen, Germany—available at m.lukosevicius@jacobs-university.de;
M. Martinetz, et al.: ““Neural-Gas” Network for Vector Quantization and its Application to Time-Series Prediction”, IEEE Transactions on Neural Networks, Vol. 4, No. 4, July 1993, pp. 558-569;
L. van der Maaten, et al.: “Visualizing Data using t-SNE”, Journal of Machine Learning Research 9 (2008), pp. 2579-2605.

### BRIEF SUMMARY

Despite such an extensive activity, improved solutions are still desirable, for instance as regards one or more of the following aspects:
providing time-varying data follower neural networks adapted for performing activity classification,
capability of supporting natively time-variant signals and providing a time-variant output with a matching frequency, e.g., with a one-to-one relationship between input signals and output;
capability of receiving signals such as accelerometer signals from a measuring device and identifying via a classifier activities being performed;
capability of processing combined accelerometer and gyroscope inputs;
capability of self-allocating and self-organizing a neural network topology depending on input data even without supervision;
capability of self-creating activation patterns of activation of a selected group of neurons even without supervision.

One or more embodiments contribute in providing such improved solution by means of a neural network having the features set forth in the claims that follow.

One or more embodiments may also concern a corresponding device (e.g., an activity recognition device), corresponding apparatus (e.g., a wearable apparatus, e.g., for sports and fitness activities) as well as a computer program product loadable in the transitory or non-transitory memory of at least one processing module (e.g., a computer) and including software code portions for executing the steps of the method when the product is run on at least one processing module. As used herein, reference to such a computer program product is understood as being equivalent to reference to a transitory or non-transitory computer-readable medium containing instructions for controlling the processing system in order to co-ordinate implementation of the method according to one or more embodiments. Reference to “at least one computer” is intended to highlight the possibility for one or more embodiments to be implemented in modular and/or distributed form.

The claims are an integral part of the disclosure as provided herein.

One or more embodiments may address the problem of classifying time-varying activities performed by a user based on accelerometer measurements provided by an on-body sensor, with accelerometer sensing possibly combined with gyroscope sensing.

One or more embodiments may provide a self-organizing neural network, namely a neural network capable of autonomously organizing connections of neurons (thus organizing network topology and neuron allocation) according to inputs fed thereto with the capability of continuously learning from data and thus improving performance over time, for instance with the capability of adapting to the wearer of wearable device.

One or more embodiments may provide a network capable of learning from time variance of data.

One or more embodiments may provide a network capable of performing, along with conventional supervised training, incremental un-supervised training on large unlabeled data sets with the capability of evolving to a specialized network permitting more accurate classification.

One or more embodiments may be adapted for use in connection with human activity recognition data sets, with performance notably improved in comparison with other recurrent-based approaches and Convolutional Neural Networks (CNNs).

### BRIEF DESCRIPTION OF THE SEVERAL VIEWS OF THE DRAWINGS

One or more embodiments will now be described, by way of example only, with reference to the annexed figures, wherein:

FIG. 1 is exemplary of the architecture of a neuron in an Echo State Network (ESN),

FIG. 2 is a block diagram exemplary of an Echo State Network,

FIG. 3 is exemplary of the layout of a neuron in a neural network according to embodiments,

FIGS. 4 and 5 are diagrams exemplary of computation of neuron activation contribution in embodiments,

FIGS. 6 and 7 are diagrams exemplary of possible behavior of embodiments,

FIG. 8 is exemplary of connections of neurons and weights in embodiments,

FIG. 9, which includes two portions indicated a) and b) is exemplary of neural gas update model applied to neurons as shown in FIG. 4,

FIG. 10 is a scheme exemplary of classifier training in embodiments,

FIG. 11 is a diagram exemplary of a self-organizing network according to embodiments.

### DETAILED DESCRIPTION

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in one or more points of the present description do not necessarily refer to one and the same embodiment. Moreover, particular conformations, structures, or characteristics may be combined in any adequate way in one or more embodiments.

The references used herein are provided merely for convenience and hence do not define the extent of protection or the scope of the embodiments.

Feed Forward Neural Networks (FFNNs) are exemplary of a first approach to neural networks including layers of interconnected neurons in a Directed Acyclic Graph (DAG), in which an input signal flows and subsequently activates or inhibits the units to which it is fed. Such networks do not permit inner feedback at any level and have no memory of previous (earlier) states. Also, FFNNs do not admit time-variant inputs: they sample, so to say, “snapshots” of a time series and perform classification by operating on a sort of “still image” of data. Consequently, such networks are hardly applicable to a context involving activities that are time-varying: in that case, classification results may be very poor, especially during transitions between different activities.

Another approach to neural networks involves so-called recurrent neural networks. These networks include layers of neurons admitting an inner feedback mechanism and back propagation of states. A major drawback of recurrent neural networks may lie in that such networks may prove hard to train (off line).

So-called reservoir computing is a branch of recurrent neural networks which addresses the complexity of training by introducing some simplifications. Reservoir computing uses large, randomly generated, sparse sets of neurons (called reservoirs) in order to process an input signal. An input signal flows in a reservoir stage and its dimensionality is expanded within that stage, with the goal of making it easier for the readout stage to perform classification of the expanded signal.

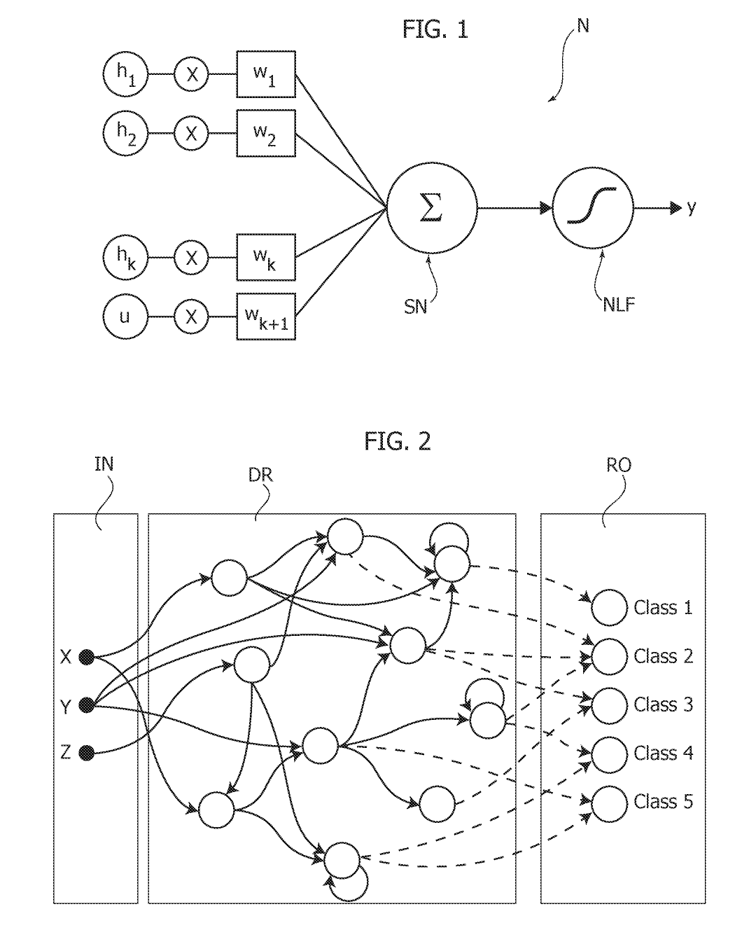

FIG. 1 is exemplary of a possible architecture of a neuron N wherein inputs h₁, h₂, . . . are multiplied (scalar product) by respective weights (activations) w1, w2, . . . and then summed at a summation node SN with an output y obtained by applying a non-linear function (NLF—for instance a sigmoid function) to the result of summation at the summation node SN. In FIG. 1 u is generally exemplary of a signal representative of inputs (e.g., acceleration signals on axes x, y, z as provided by an accelerometer: see X, Y, Z in FIG. 2).

The diagram of FIG. 1 is exemplary of a neuron unit which can be included in an echo state network (ESN) as exemplified in FIG. 2 and including input nodes IN (e.g., X, Y, Z), a dynamic reservoir stage DR and a readout stage RO, providing classification results Class 1, Class 2, . . . .

Echo state networks as exemplified in FIG. 2 can simplify the training process in a recurrent neural network in so far as such a network can be operated by training the readout weights only, therefore allowing a faster deployment of the network.

In the diagram of FIG. 2, each line represents (implicit) multiplication of the output of a neuron by the trained weights and only weights exemplified by dashed lines are trained.

A major drawback of such an approach may lie in the difficulty in achieving high performance, e.g., due to the reduced freedom of the underlying model, with few parameters adapted to be tuned in order to improve a performance. Such a drawback is confirmed by poor accuracy shown in tests performed on available datasets.

Certain investigations concerning the idea of a self-organizing reservoir have focused, e.g., on Kohonen's self-organizing maps as a training model. Such an approach has a limit in the fixed network topology (like a fishnet) which is unable to evolve and adapt to inputs, e.g., using a different learning model. This eventually resulted in experiments limited to a few tests without the ability of performing in-depth analysis.

One or more embodiments may address the issues discussed in the foregoing by means of a self-organizing reservoir network which can be categorized as a recurrent neural network, that is a neural network that allows feedback loops with a memory of the previous (earlier) states.

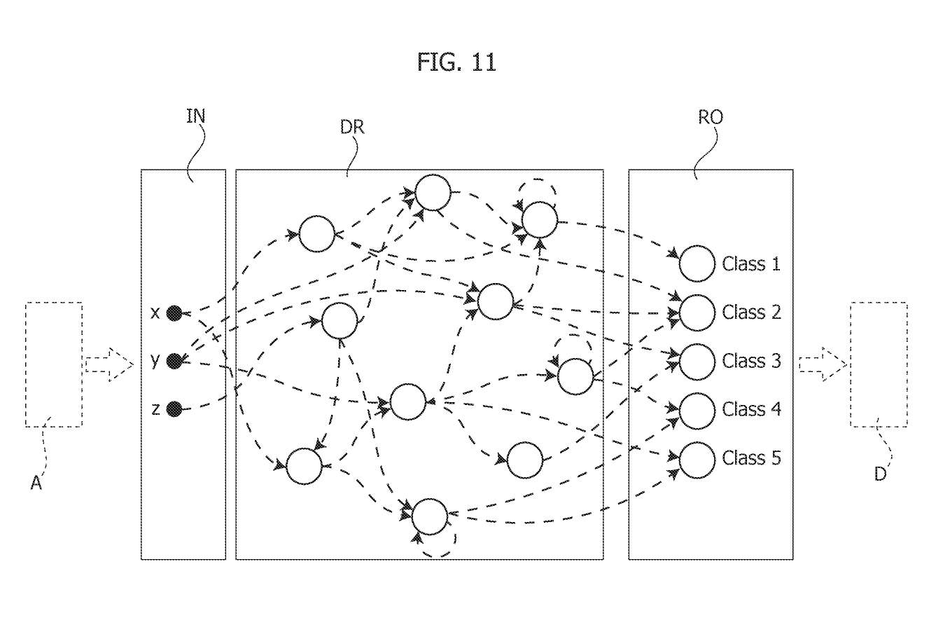

Such an arrangement may include a pool of neurons and respective connections forming a dynamic reservoir stage DR (see, e.g., FIG. 11, to be discussed later, by way of direct comparison with FIG. 2).

In one or more embodiments such a pool of neurons and their connections can be generated randomly and then trained via (unsupervised) machine learning in order to specialize the network, so that the network can react more effectively to input signals.

In one or more embodiments, training and configuration of the network may involve three different acts:
unsupervised training of the reservoir stage DR,
supervised training of the readout stage RO,
deployment of the whole trained network.

One or more embodiments may rely on a neuron module which can be regarded as a modified version of the neuron in an echo state network as discussed in the foregoing. In one or more embodiments, such a neuron module makes it possible to evaluate (numerically) a distance between the neuron and the signal fed to the neurons with the neurons adapted to such signal(s).

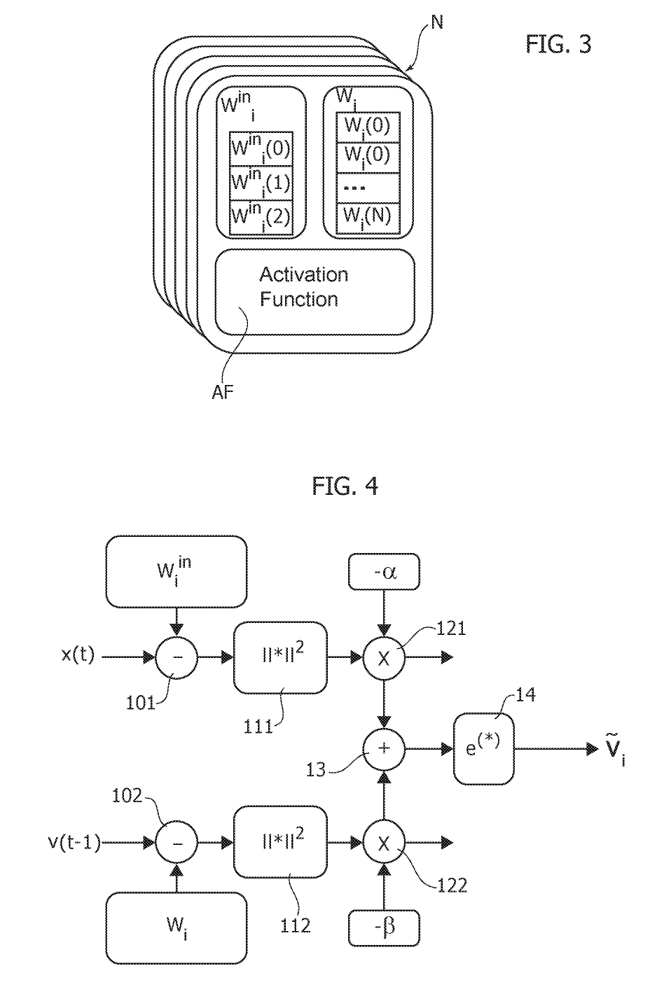

A neural network according to one or more embodiments may include neurons according to the model exemplified in FIG. 3.

Such a neuron model (“unit”) may lie at the basis of a self-organizing neural network embodying an array of weights representing the connections between a certain neuron and (all) other neurons in the network. Reference to—all—the neurons in the network indicates that “self-connection” of a neuron with the neuron itself may be included.

In the schematic representation of FIG. 3, N indicates the number of neurons while W₁ represents connections between the “current” neuron being considered and all the other neurons. Also, Wⁱⁿᵢ represents connections between a current neuron and the input. Finally, an activation function AF determines the response of the neuron, that is how the final value depends on (that is a function of) the input signal.

By way of a (non-limiting) example of a possible use of one or more embodiments, one may consider the case where the input connections are used to map a signal from an accelerometer A (see FIG. 11) such as data on three dimensions X, Y, Z—possibly with associated gyroscope data—to provide corresponding classifications (e.g., type of activity: Class 1, Class 2, . . . ). For instance, these can be presented on a display unit D and/or used in an application other than visualization (such as calculation of consumption of calories or degree of sedentarity, providing a type of alert or alarm and so on).

In one or more embodiments, the input connections of the neurons, used to map the accelerometer signal on the reservoir, may be encoded as a set of weights.

In order to create an operating network with, say, 100 neurons (this is again a purely exemplary value), an input can be generated represented by a (100×3) matrix of weights Wⁱⁿ (boldface representation of a matrix is avoided herein for simplicity) each row in the matrix representing the connections that link each dimension of the input signal to the neuron.

In a similar way, the reservoir connections of the neurons may represent the weights of the connections of a neuron to all the units in the reservoir (possibly including the neuron/unit itself).

The neurons in the reservoir may be represented, in such an example, by a (100×100) weight matrix W, each row in the matrix representing the connections that link the neurons of the reservoir to that given neuron.

In one or more embodiments, a first act towards the development of a self-organizing reservoir neural network involves the definition of a new model to compute the activation of each neuron.

Throughout the following discussion:
x(t) will denote the input signal coming from, e.g., an input sensor (such as a 3-d accelerometer A),
v(t) will denote the network activation values.

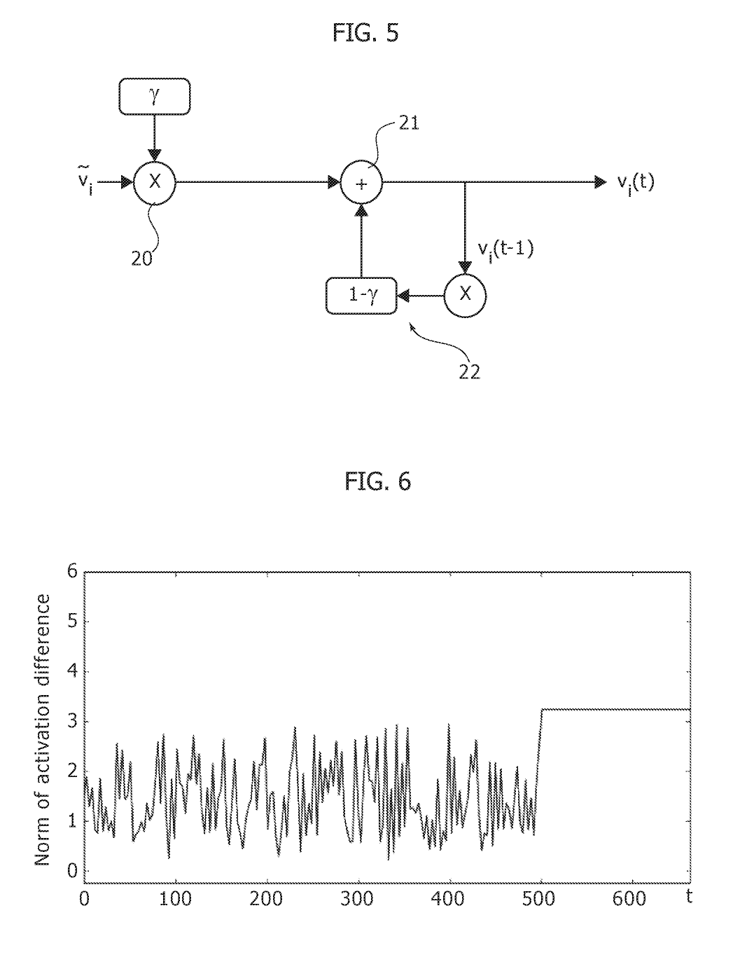

The diagrams of FIGS. 4 and 5 are exemplary of a possible approach in computing the neuron activation contribution at a “current” step, which may also include a leaky integration of the current activation with the activation at a previous (earlier) stage.

In the diagram of FIG. 4 the signals x(t) and v(t−1)—that is the input signal at time t and the network activation at an earlier time t−1 are fed to two summation nodes 101, 102 to which respective values Wᵢⁱⁿ and Wᵢ are fed (with opposed signs, the nodes 101, 102 acting actually as subtraction nodes). The outputs from the nodes 101, 102 (that is the differences x(t)−Wᵢⁱⁿ and v(t−1)−Wᵢ) are fed to modulus square blocks 111, 112 with the respective results in turn fed to multiplication nodes 121, 122 to be multiplied by respective (negative) factors −α and −β.

The elements just described are thus exemplary of calculating the L2 norm of the two differences, namely the Euclidean distance between two vectors. Such an entity is representative of the distance between the input signals at time t and certain weights and the distance between the activation signals at time t−1 and certain weights.

The results of multiplication at 121, 122 are then added in a summation node 13 with the result of summation fed to a stage 14 applying a non-linear (e.g., exponential e^{(*)}) function to provide a value v^{˜}ᵢ.

The value v^{˜}ᵢ thus obtained (see the transition from FIG. 4 to FIG. 5) is then further processed to obtain an (updated) value vᵢ(t). Such further processing as exemplified in FIG. 5 includes feeding the value to a multiplier stage 20 to be multiplied by a factor γ (less than unity) with the result subjected to “leaky” integration. Such type of integration may include adding at a summation node 21 the result of multiplication at node 20 plus a previous (earlier) value for vᵢ(t), namely vᵢ(t−1), multiplied at 22 for a coefficient 1−γ (that is the complement to one of the multiplication parameter γ applied at node 20), thus implementing an (exponential) moving average.

In one or more embodiments, the level of activation of each neuron N may thus depend on the input signal at the current time instant x(t) and on the level of activation of the reservoir at the previous (earlier) instant v(t−1).

In one or more embodiments as exemplified in FIGS. 4 and 5 the blocks 101, 102, 111, 112 compute distances as Euclidean distances between the input signal x(t) and each unit in Wᵢⁱⁿ and between the activation at the previous (earlier) step v(t−1) and each unit in Wᵢ.

It will be appreciated that, throughout this description, reference to Euclidean distances is merely exemplary and not limitative of the embodiments; one or more embodiments may involve using other types of distances: see, e.g., https://en.wikipedia.org/wiki/Distance (Mathematics).

Multiplication by the factors −α and −β are exemplary of the activation contribution of both Wᵢₙⁱⁿ and Wᵢ being somehow “dampened,” e.g., before the overall contribution is computed at 14 as an exponential function of the sum computed in the summation node 13.

In one or more embodiments, the leaky integration exemplified by the diagram of FIG. 5 facilitates stability of the network (and as well temporal decoupling of the input and output signals).

The role of the leaky integration exemplified in FIG. 5 may be appreciated by plotting the difference between activation at a current step and activation at the previous one in the presence of a constant input.

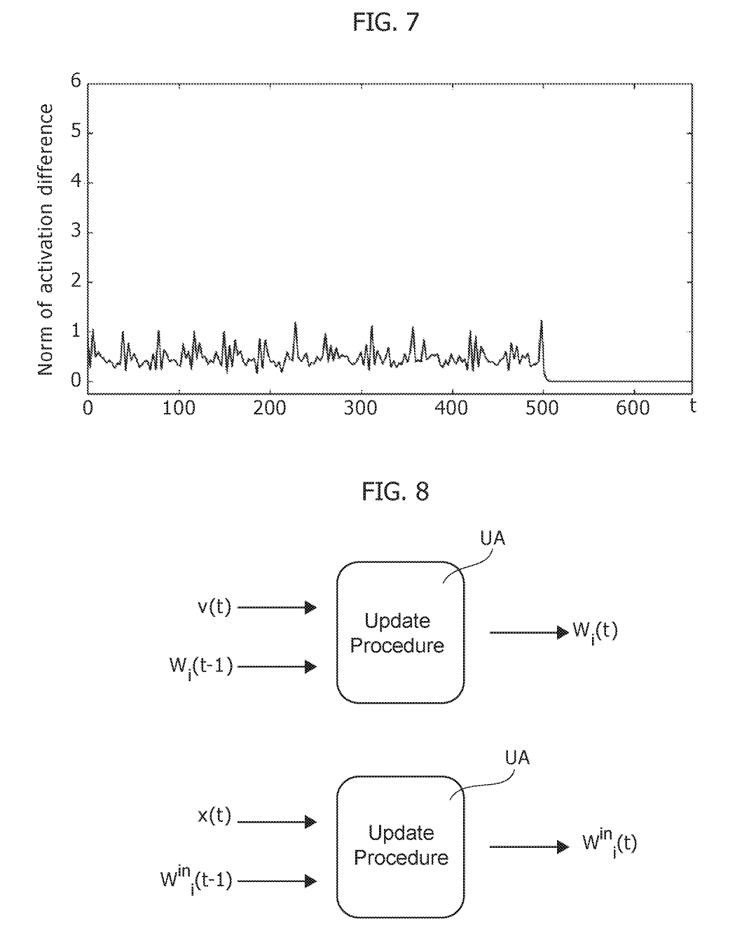

The diagrams of FIGS. 6 and 7, where the norm of activation differences (ordinate scale) is plotted against time (abscissa scale), are representative of the results of stability test performed by using unitary values for the multiplication factors α and β (nodes 121 and 122 in FIG. 4) with the parameter γ (see FIG. 5) set to unity (diagram of FIGS. 6) and to 0.5 (diagram of FIG. 7), respectively.

The diagrams (plots) of FIGS. 6 and 7 assume that the network is fed at first with a certain sequence (e.g., walking sequence) with the input artificially stabilized at a given value (for instance 0, 0, 0) with the difference of activation plotted at subsequent steps.

Comparison of FIGS. 6 and 7 shows a possible role of the parameter γ in controlling the resistance of the network with respect to changes in activation.

High values of γ (e.g., 1) lead to a (highly) reactive network, where the contribution of activation at the current instant (see FIG. 4) dominates over the contribution of the activation at the previous step (multiplied by 1−γ, see FIG. 5).

In FIG. 6 (in practice with no integration of the previous step: with γ=1 the contribution of the previous step is set to zero) the norm of the difference between two subsequent samples (when receiving a stabile input) is constant, with the activation of the network oscillating.

In FIG. 7, with (very) low integration of the previous step (in fact γ=0.5 is a relatively large value, plotted as an example: in practical applications γ may be set to values around, e.g., 10⁻²), the norm of the difference between two subsequent samples (when receiving a stable input) decreases to zero, this being indicative of the activation of the network being stabilized.

To sum up: convergence to a stable output becomes increasingly faster for increasingly smaller values for γ.

As noted, leaky integration may also facilitate temporal decoupling between the input and the output of the network, the latter varying at (much) lower rate than the input.

It will be appreciated that in a self-organizing reservoir, activation is computed via a norm, while in an echo state network (ESN) activation is computed via a dot product, therefore losing a per-component information. This factor may play a role in suggesting the use of self-organization.

In one or more embodiments the neurons of a self-organizing reservoir may act as “prototypes” adapted to the signal being processed.

In one or more embodiments, the reservoir training phase (involving the adaptation of the connection weights) may take place, e.g., in a dedicated workstation or in the Cloud, in view of the large number of input signals being processed.

The diagrams of FIG. 8 are exemplary of the update procedure (UA) related to the connections of each neuron and the weights to which they are adapted.

It will be appreciated that the block representation adopted throughout the figures is generally exemplary of the possibility of implementing the processing as exemplified by resorting to analog circuits, digital circuits (e.g., in SW form) and/or to a mix of analog and digital circuits.

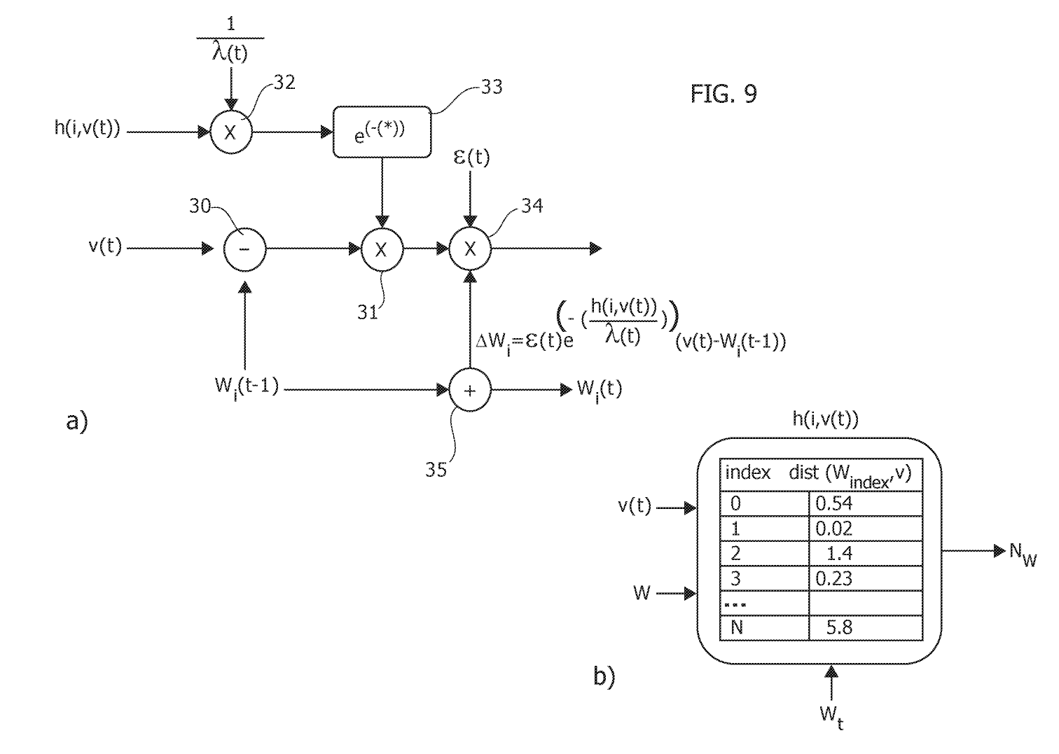

The diagram of the FIG. 9 (left-hand side) is exemplary of a training procedure which may be adopted for both the input weights and for the reservoir weights, with the input weights Wⁱⁿ adapting to the input signal and the reservoir weights W adapting to reservoir activation: consequently, while the diagram of FIG. 9 represents the model for reservoir activation, analogous processing can be applied to the input signal with x(t) in the place of v(t).

A first act in the training procedure may involve receiving the input signal, namely x(t) for Wⁱⁿ and v(t) for W. A distance (e.g., Euclidean) can then be computed between x(t) and each unit of Wⁱⁿ and between v(t) and each unit of W.

The quantity thus computed may be dampened (e.g., exponentially) by the number of units that are closer, according to a chosen distance, to the received signal (either input signal or reservoir activation).

A “learning constant” may thus be multiplied for an amount of adaptation, e.g., a constant that decays (e.g., exponentially) over the (entire) duration of the training process. The resulting effect is that the units are more mobile and adaptable at the beginning of the training process and become then “stiffer” towards the end, with all adaptations performed.

The exemplary diagram of portion a) of FIG. 9 (again, this refers by way of example to reservoir activation but analogous processing can be performed also on the input signal) shows the input value v(t) fed to a summation node 30 (with opposed signs, in a fact a subtraction node) which also receives values for Wᵢ₍ₜ₋₁₎ to compute the difference to v(t) with the resulting difference fed to a multiplication node 31.

The other input to the multiplication node 31 is provided starting from another multiplication node 32 to which input values h(i, v(t)) and 1/λ(t) (with λ(t) decaying exponentially) are fed to be multiplied with an exponential function e^{(-(*))} applied at 33.

The entity h(i,v(t)) denotes the number of units closer than the i-th one to the v(t) signal. In the exemplary case presented here this parameter is used to dampen the activation according to the number of units that are closer (and therefore more affected) to the signal v(t). For instance, it can be represented as a table including a number of lines corresponding to the number of neurons in the reservoir. At each line a value is present indicative of the distance between the weight W and its activation v. This may facilitate selecting, by ordering the table, those neurons having more or less short distances thus providing a measure of the tendency to self-aggregate by activation thus promoting grouping and specialization thereof.

The output from the multiplication node 31 is further multiplied at 34 with a coefficient ε(t) namely a learning rate coefficient which decays exponentially just like λ(t) decays exponentially.

The outcome for multiplication at 34 is an update factor ΔWᵢ

ΔWᵢ=ε(t)·e^{-h(i,v(t)/λ(t))}(v(t)−Wᵢ(t−1))

which is applied at a summation node 35 to the “old” value Wᵢ(t−1) to yield an updated value Wᵢ(t).

The right-hand portion, designated b), of FIG. 9 reports an exemplary table providing possible values of the distance dist (W_{index},v) for increasing indexes 0, . . . , N related to the number of units of W that are closer to v(t) with respect to Wᵢ.

In one or more embodiments adaptation performed by the unit can be seen as the unit “getting closer” to the input signal, by modifying its weights to reduce the distance between them and the signal.

Exponential dampening by the number of units that are closer, according to the chosen distance, to the received signal (either the input sample or reservoir activation) results in the closer units being adapted more than those units that are further away, thus facilitating better covering of signal dynamics and specialization of the units.

Also, while an exponential decay function was found to be a good choice for dampening as applied at 32 and 34 to the output from the node 30, other forms of space/time dampening (e.g., linear) may be applied in one or more embodiments.

It was observed that as result of such processing clusters tend to form leading to a more uniform distribution of the units in the respective space.

It was also observed that the effect on supervised training can be appreciated by resorting the, e.g., to the T-sne algorithm as discussed in van der Maaten, et al. (cited previously), which is useful in visualizing multi-dimensional spaces in lower-dimensional spaces. The T-sne algorithm is an unsupervised machine learning algorithm which facilitates embedding elements from high dimensional space into a space with smaller dimensions.

By resorting to that method it is possible to visualize in a scatter plot (bidimensional) the elements of both Wⁱⁿ and W belonging to 3-d and N-d space where N is the number of neurons.

As noted, another relevant effect of a self-organization is specialization of neurons. For instance it was observed that the level of activation (which may be computed by averaging the instantaneous activation after been fed with the sequence of input samples) is (much) more localized in a trained network while it is more distributed in an untrained network.

The areas of activation in the case of a training networks are more discernible which is a sign of specialization.

In one or more embodiments, after a first training as exemplified in the foregoing, the reservoir (DR in the diagram of FIG. 11) can be set and remain as it is with the training procedure transferred to the training of the readout stage RO.

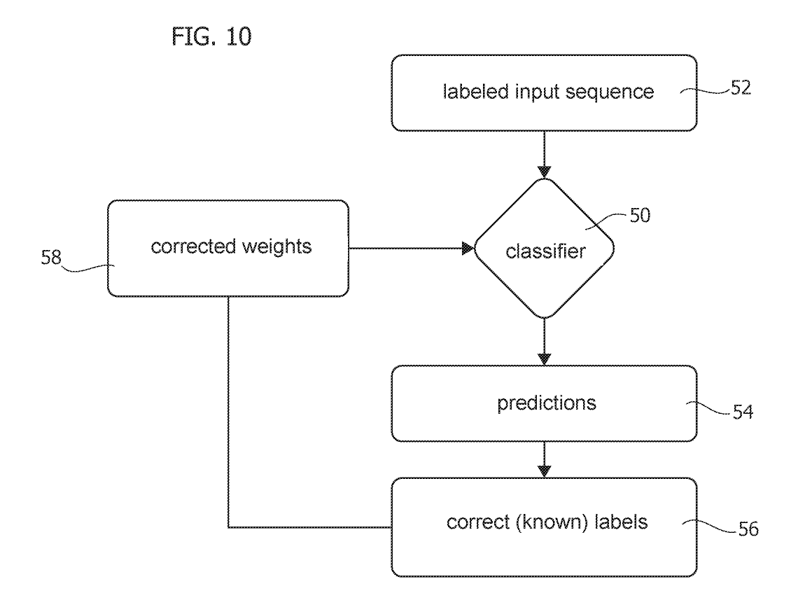

To that effect (classifier training) one or more embodiments may adopt a procedure as schematically represented in FIG. 10.

In the diagram of FIG. 10, the classifier stage is denoted by 50 and the reference 52 is indicative of “labeled” input sequences from which the classifier 50 can calculate a set of predictions 54. These predictions can be compared with correct (known) labels indicated 56 to produce correct classifier weights that are supplied to the classifier 50 as a result of training.

For instance, in one or more embodiments, the network may be fed with input samples belonging to known classes (the labeled inputs) and the network readout (namely the classifier 50) can be trained to associate to reservoir activation values certain output classes. By referring to the non-limiting example of an accelerometer signal in a wearable device from which activity classes are derived, these output classes may include classes such as jogging, walking, biking, stationary and so on.

Such a procedure can be repeated iteratively until a desired level of accuracy (precision) is achieved, e.g.:
input fed to the network,
activations computed,
activations fed to the classifier, along with the label that classify the input sequences,
classifier trained in order to make its prediction fit the labels.

Again, such a phase of the training process can be performed either in a workstation, in a mobile device or in the Cloud.

The possibility also exist of performing a “major” classifier training either at a work station or in the Cloud with incremental training performed in a mobile device thus allowing a finer tuning of the parameters which facilitates adaptation to the specific wearer.

Once the training phase is completed, the network is ready to be operated/deployed, by accepting input signals (for instance accelerometer signals) and providing classifications as schematically represented in the diagram of FIG. 11.

In FIG. 11 the same designations of FIG. 2 apply, with a difference given by the fact that in a self-organizing network dashed lines may be present which are exemplary of trained weights (by way of direct comparison with the diagram of FIG. 2), with the neurons in the network of FIG. 11 assumed to be modeled as exemplified in FIGS. 3, 4 and 5.

One or more embodiments lend themselves to be embedded in wearable devices powered, e.g., with a microcontroller of the STM 32 family available with the applicant company.

As regards complexity, by designating N-dim the number of dimensions of the input signal and N the number of neurons in the network, the following operations are performed for each sample in a network as exemplified in the foregoing (MAC=Multiply-ACcumulate operation):

N*(3+2*(N−dim+N)MAC+1 exponential (which can be approximated with about 5 MAC) in order to compute a current contribution (see FIG. 4)

2*(N+1) MAC to compute the leaky integration of FIG. 5

the total cost of a single iteration can be estimated as 2N−dim+4N+10 MAC.

By way of example, by assuming a 100-neuron network that processes accelerometer signals (natively 3-d), the computational costs for each input sample is:

N=100,N−dim=3

100*(3+2*(3+100)+5)=21400 MAC for the activation at current step

2*(101)=202 MAC for the leaky integration

the total cost for computing the activation for each sample is 21602 MACC

By assuming a 16 Hz accelerometer sensor providing input to the network, the total cost is about 345,632 MAC/sec.

By referring to a more computationally-demanding and complex example, one may assume having input signals from a 3-d accelerometer paired with a 3-d gyroscope:

N=100,N−dim=6

100*(6+2*(6+100)+5)=22300 MAC for the activation at current step

2*(101)=202 MACC for the leaky integration

the total cost for computing the activation for each sample is 22502 MACC

Assuming a 16 Hz accelerometer sensor providing input to the network the total cost is about 360,032 MAC/sec, that is an amount slightly higher than the processing cost for handling the 3-d accelerometer signals only.

By referring to training of the reservoir based on the neural model discussed previously, the readout classifier turns out to be appreciably simpler in comparison to those of other neural network-based approaches with the cost of training being appreciably lower in comparison with back-propagation methods used for training feedforward neural networks.

For instance, the following table reports evaluation results in terms of confusion matrix referring to testing a 500-neuron conventional Echo State Network (ESN) with an average recall (AR): 71.02%

| | Predicted | Predicted | Predicted | Predicted | Predicted | Predicted |
|---|---|---|---|---|---|---|
| | as 1: | as 2: | as 4: | as 6: | as 7: | as 9: |
| | Stationary | Standing | Walking | Jogging | Biking | Driving |
| Stationary | 99.73 | 0.04 | 0.03 | 0.10 | 0.06 | 0.05 |
| Standing | 5.68 | 51.86 | 18.66 | 0.14 | 10.32 | 13.33 |
| Walking | 7.50 | 14.27 | 38.57 | 9.40 | 16.31 | 13.96 |
| Jogging | 1.99 | 5.52 | 5.63 | 78.95 | 4.80 | 3.11 |
| Biking | 2.85 | 0.97 | 1.25 | 2.68 | 84.51 | 7.75 |
| Driving | 14.09 | 3.83 | 4.40 | 0.33 | 4.86 | 72.49 |

The following table reports by way of comparison the results obtained in testing a 500-neuron network based on the self-organizing reservoir approach discussed herein having an average recall with (AR): 98.33%

| | Predicted | Predicted | Predicted | Predicted | Predicted | Predicted |
|---|---|---|---|---|---|---|
| | as 1: | as 2: | as 4: | as 6: | as 7: | as 9: |
| | Stationary | Standing | Walking | Jogging | Biking | Driving |
| Stationary | 98.14 | 0.25 | 0.31 | 0.18 | 0.54 | 0.57 |
| Standing | 0.19 | 98.31 | 0.25 | 0.23 | 0.49 | 0.53 |
| Walking | 0.26 | 0.34 | 98.52 | 0.53 | 0.14 | 0.21 |
| Jogging | 0.13 | 0.19 | 0.54 | 99.10 | 0.01 | 0.03 |
| Biking | 0.31 | 0.35 | 0.04 | 0.04 | 98.39 | 0.88 |
| Driving | 1.00 | 1.14 | 0.03 | 0.00 | 0.29 | 97.54 |

Operation of a neural network as discussed herein is essentially deterministic: for a given input sequence the network will expectedly output a same sequence (all seeds of the pseudo-random number generated can be explicitly controlled in order to obtain such a deterministic control). Consequently, the same exact output sequence being obtained given a same input sequence is indicative of the self-organizing neural network approach discussed herein being adopted.

In one or more embodiments a neural network (e.g., IN, DR, RO) may include at least one layer (DR) of neurons (e.g., N) including neurons having neuron connections to neurons in the at least one layer and input connections to a network input (e.g., X, Y, Z), wherein the neuron connections and the input connections have respective neuron connection weights (e.g., Wᵢ) and input connection weights (e.g., Wᵢⁱⁿ), wherein said neurons have neuron responses set by an activation function (e.g., AF) with activation values (e.g., vᵢ(t), vᵢ(t−1)) variable over time, said neurons including activation function computing circuits (see, e.g., 101, 102, 111, 112, 121, 122, 13, 14, 20, 21, 22 in FIGS. 4 and 5) configured for computing current activation values of the activation function as a function of previous activation values of the activation function and current network input values.

In one or more embodiments, the neuron connections may include neuron self-connections (that is, with the neuron itself).

In one or more embodiments said activation function computing circuits may include:
distance computing blocks (e.g., 101, 111; 102, 112) with a first output (e.g., 111) indicative of a distance between said current network input (e.g., x(t)) and a respective input connection weight (e.g., Wᵢⁱⁿ) and a second output (e.g., 112) indicative of a distance between said previous activation value (e.g., vᵢ₍ₜ₋₁₎) and a respective neuron connection weight (e.g., Wᵢ),
an exponential module (e.g., 14) applying an exponential function to a sum (e.g., 13) of said first and second outputs.

In one or more embodiments, the distance computing modules may be configured to compute said distances as Euclidean distances.

One or more embodiments may include dampening modules (e.g., 121, 122) applying dampening factors (e.g., α, β) to said first and second outputs summed to provide said sum of said first and second outputs.

In one or more embodiments, said activation function computing circuits may include a leaky integration stage coupled to the output of said exponential module.

One or more embodiments may include:
a multiplier (e.g., 20) by a gain factor (e.g., γ) less than unity coupling the output of said exponential module to the input of the leaky integration stage,
the leaky integration stage including a leaky feedback loop (e.g., 22) with a leak factor (e.g., 1−Y) which is the complement to unity of said gain factor less than unity.

In one or more embodiments a device may include:
a sensor (e.g., A) to provide a sensor signal,
a neural network according to one or more embodiments, the neural network including an input stage (e.g., IN) coupled to said sensor to receive said sensor signal as said network input and a readout stage (e.g., RO) to provide a network-processed output signal.

In one or more embodiments the sensor may include an accelerometer, optionally coupled with a gyrometer (e.g., a gyroscope), providing activity signals, said network-processed output including classifications of said activity signals.

Apparatus according to one or more embodiments (e.g., wearable fitness apparatus) may include:
a device according to one or more embodiments, and
a presentation unit (e.g., D) for presenting said network-processed output signal.

In one or more embodiments a method of adaptively setting said respective neuron connection weights and input weights in a network according to one or more embodiments may include:
receiving an input value (e.g., x(t), v(t)) for said input weights and connection weights,
calculating (e.g., 30) a distance between said input values and respective input and connection weights (Wᵢ),
applying (e.g., 31, 34) dampening to the distance calculated, said dampening including:
i) first dampening (e.g., 31, 32, 33) with a decay which is a function, optionally exponential, of the distance to the neighboring neurons in said at least one layer (D),
ii) second learning rate dampening with a decay which is a function, optionally exponential, of time,
calculating updates (e.g., ΔWᵢ) for said respective neuron connection weights and input weights as a function of said distance calculated with said dampening applied.

In one or more embodiments the network may include a classification readout stage (e.g., RO) configured for providing classification of signals input to the neural network, the method including, subsequent to adaptively setting said respective network connection weights and input weights:
receiving (e.g., 52) a set of known input signals at said classification readout stage (e.g., RO; 50),
operating said readout stage to provide candidate classifications for said known input signals,
comparing (e.g., 56) said candidate classifications with known classifications for said known input signals,
correcting (58) the weights in the nodes in said readout stage of the neural network having correspondence of said candidate classifications with said known classifications as a target.

In one or more embodiments a computer program product, loadable in the memory of at least one computer may include software code portions for performing the steps of the method of one or more embodiments.

Without prejudice to the underlying principles, the details and embodiments may vary, even significantly, with respect to what has been described herein by way of example only, without departing from the extent of protection.

The extent of protection is defined by the annexed claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A neural network, comprising:
at least one layer of a plurality of neurons, the plurality of neurons including neuron connections and input connections, the neuron connections between neurons in the at least one layer of said plurality of neurons, and the input connections between neurons in the at least one layer of said plurality of connections and a network input, wherein the neuron connections and the input connections have respective neuron connection weights and input connection weights, wherein neurons in the at least one layer of said plurality of neurons have neuron responses set by an activation function with activation values variable over time, at least one layer of said plurality of said plurality of neurons including activation function computing circuits configured to compute current activation values of the activation function as a function of previous activation values of the activation function and current network input values.

2. The neural network of claim 1, wherein the neuron connections include neuron self-connections.

3. The neural network of claim 1, wherein said activation function computing circuits comprise:
distance computing blocks arranged to produce a first output indicative of a distance between said current network input and a respective input connection weight, and arranged to produce a second output indicative of a distance between said previous activation value and a respective neuron connection weight; and
an exponential module arranged to apply an exponential function to a sum of said first and second outputs.

4. The neural network of claim 3, wherein the distance computing modules are configured to compute said distances as Euclidean distances.

5. The neural network of claim 3, comprising:
dampening modules arranged to apply dampening factors to said first and second outputs summed to provide said sum of said first and second outputs.

6. The neural network of claim 3, wherein said activation function computing circuits include a leaky integration stage coupled to an output of said exponential module.

7. The neural network of claim 6, including:
a multiplier arranged to multiply by a gain factor less than unity, the multiplier coupling the output of said exponential module to an input of the leaky integration stage, wherein the leaky integration stage includes a leaky feedback loop with a leak factor which is complementary to unity of said gain factor less than unity.

8. A device, including:
a sensor to provide a sensor signal; and
a neural network, the neural network including:
at least one layer of a plurality of neurons, the plurality of neurons including neuron connections and input connections, the neuron connections between neurons in the at least one layer of said plurality of neurons, and the input connections between neurons in the at least one layer of said plurality of connections and a network input, wherein the neuron connections and the input connections have respective neuron connection weights and input connection weights, wherein neurons in the at least one layer of said plurality of neurons have neuron responses set by an activation function with activation values variable over time, at least one layer of said plurality of said plurality of neurons including activation function computing circuits configured to compute current activation values of the activation function as a function of previous activation values of the activation function and current network input values;
an input stage coupled to said sensor and configured to receive said sensor signal as said network input; and
a readout stage to provide a network-processed output signal.

9. The device of claim 8, wherein the sensor comprises:
an accelerometer coupled to the input stage, the accelerometer configured to provide activity signals, wherein said network-processed output is arranged to include classifications of said activity signals.

10. The device of claim 9, comprising:
a gyroscope coupled to the accelerometer and arranged to provide activity signals.

11. The device of claim 8, wherein the device is a wearable computing device.

12. The device of claim 8, comprising:
a presentation unit arranged to present said network-processed output signal.

13. The device of claim 12, wherein the presentation unit is further arranged to present an activity classification that classifies the network-processed output signal.

14. A method of adaptively setting neuron connection weights and input weights in a self-organizing neural network, comprising:
providing a neural network having at least one layer of a plurality of neurons, the plurality of neurons including neuron connections and input connections, the neuron connections between neurons in the at least one layer of said plurality of neurons, and the input connections between neurons in the at least one layer of said plurality of connections and a network input, wherein the neuron connections and the input connections have, respectively, the neuron connection weights and the input connection weights;
receiving input values, the input values including at least one input value for said input weights and at least one input value for said connection weights;
calculating a distance between said input values and, respectively, said input weights and said connection weights;
applying dampening to the distance calculated, said dampening including:
i) first dampening with a distance decay which is a function of distance to neighboring neurons in said at least one layer and
ii) second learning rate dampening with a time decay which is a function of time; and
calculating updates for said respective neuron connection weights and input weights as a function of said distance calculated with said dampening applied.

15. The device of claim 14, wherein the function of distance and the function of time are exponential functions.

16. The method of claim 14, wherein the neural network includes a classification readout stage configured to provide classification of signals that are input to the neural network, the method comprising:
subsequent to adaptively setting said neuron connection weights and input weights:
receiving a set of known input signals at said classification readout stage;
operating said classification readout stage to provide candidate classifications for said known input signals;
comparing said candidate classifications with known classifications for said known input signals; and
correcting the neuron connection weights and input weights in nodes in said classification readout stage of the neural network targeting correspondence of said candidate classifications with said known classifications.

17. The device of claim 16, wherein said signals that are input to the neural network are signals from at least one of an accelerometer and a gyroscope.

18. A non-transitory computer program product, loadable in the memory of at least one computer and including software code portions executable by a processor to perform a method, the method comprising:
providing a self-organizing neural network having at least one layer of a plurality of neurons, the plurality of neurons including neuron connections and input connections, the neuron connections between neurons in the at least one layer of said plurality of neurons, and the input connections between neurons in the at least one layer of said plurality of connections and a network input, wherein the neuron connections and the input connections have, respectively, the neuron connection weights and the input connection weights;
passing sensor signals to the network input of said self-organizing neural network; and
passing a network-processed output signal to a readout stage.

19. The non-transitory computer program product of claim 18, the method comprising:
setting neuron connection weights and input weights in the self-organizing neural network;
receiving input values, the input values including at least one input value for said input weights and at least one input value for said connection weights;
calculating a distance between said input values and, respectively, said input weights and said connection weights;
applying dampening to the distance calculated, said dampening including:
i) first dampening with a distance decay which is a function of distance to neighboring neurons in said at least one layer and
ii) second learning rate dampening with a time decay which is a function of time; and
calculating updates for said respective neuron connection weights and input weights as a function of said distance calculated with said dampening applied.

20. The non-transitory computer program product of claim 19, the method comprising:
after setting said neuron connection weights and said input weights:
receiving a set of known input signals at a classification readout stage;
operating said classification readout stage to provide candidate classifications for said set of known input signals;
comparing said candidate classifications with known classifications for said known input signals; and
correcting the neuron connection weights and input weights in nodes in said classification readout stage of the neural network targeting correspondence of said candidate classifications with said known classifications.
